(19) United States
(12) Patent Application Publication
(10) Pub. No.: US 2002/0176329 A1
(43) Pub. Date: Nov. 28, 2002

(54) Headset data disk player

(76) Inventor: Roland Ramonowski, Schenectady, NY (US)

Correspondence Address: HOFFMAN WARNICK & D'ALESSANDRO, LLC, 3 E-COMM SQUARE, ALBANY, NY, 12207

(21) Appl. No.: 09/863,112

(22) Filed: May 22, 2001

(51) Int. Cl. G11B 7/085

(52) U.S. Cl. 369/30.36

(57) ABSTRACT

A headset data disk player having a head assembly for securing to the head of a user, with a data disk reader and at least one housing, including a speaker, coupled to it wherein the data disk reader communicates with each of the speakers.

### BACKGROUND OF THE INVENTION

1. Technical Field

The present invention relates generally to a portable compact disk player, and more particularly, to a headset with a data disk reader and a speaker coupled to it.

2. Related Art

Portable compact disk players are favored mechanisms for listening to audio such as music while walking, running or doing any other sort of activity that requires movement. The typical compact disk player reads information from a compact disk, a mini disk and other forms of data storage devices. The players are typically compact and portable/hand-held.

The body of a portable compact disk player is usually made from a mold that is tooled and/or shaped to correspond to the size that is needed to encompass the elements for the electronic parts and the compact disk. The materials used to make the body of the compact disk are usually a form of polyurethane, polyethylene or the like. The body is made to be light, strong and resistant to elements like moisture, sweat and dirt.

Unfortunately, currently available compact disk players suffer from a number of disadvantages. For instance, when using existing players, it is necessary to have a set of headphones with wires attached to a separate compact disk player to hear the music. The wires dangle and constantly interfere with movement while doing any activity requiring motion. The dangling wires are also unsafe when participating in any activity requiring movement. It is very easy for the wire to get entangled around a stationary object and place the user in danger.

Another disadvantage of currently available compact disk players is that the compact disk player has to be carried. While participating in any activity requiring movement, it is beneficial to have the hands free of any object.

Another disadvantage of currently available compact disk players is that the player has to be held or attached to the body by a clip of some sort. The player can be destroyed by accidently dropping it or from the clip breaking, having the player drop to the ground.

In view of the foregoing, there is a need for a headset with an attached data disk player.

### BRIEF SUMMARY OF THE INVENTION

In a first aspect of the invention is provided a headset comprising a head assembly for securing to the head of a user; at least one housing, including a speaker, coupled to the head assembly; and a data disk reader coupled to one of the head assembly and the at least one housing. The data disk reader communicates with each speaker.

In a second aspect of the invention is provided a headset having a head assembly for securing to the head of a user, the headset comprising at least one housing, including a speaker, coupled to the head assembly, a data disk reader coupled to one of the first assembly and the at least one housing that communicates with each speaker, and at least one power source that provides power to operate the data disk reader.

In a third aspect of the invention is provided a headset comprising a first assembly for securing to the head of a user, at least one housing, including a speaker, coupled to the first assembly, a second assembly coupled to one of the first assembly and the at least one housing, and a data disk reader coupled to one of the first assembly, second assembly and the at least one housing that communicates with each of the speakers.

In a fourth aspect of the invention is provided a portable data disk reader for use with a headset having a head assembly for securing to the head of a user and at least one speaker. The data disk reader comprises means for reading a data disk, means for attaching the means for reading a data disk to the head assembly, means for communicating the means for reading a data disk to each of the at least one speakers, and means for supplying power to the means for reading a data disk.

In a fifth aspect of the invention is provided a headset having means for securing the headset to the head of a user and at least one speaker. The headset comprising means for reading a data disk coupled to the means for securing the headset on the head of a user, means for communicating the means for reading a data disk with each of the at least one speaker, and means for supplying power to the means for reading a data disk.

The foregoing and other features and advantages of the invention will be apparent from the following more particular description of the preferred embodiments of the invention.

### BRIEF DESCRIPTION OF THE DRAWINGS

Various embodiments of this invention will be described in detail, with reference to the following figures, wherein like designations denote like elements, and wherein:

FIG. 1 is a front view of a headset data disk player according to a first embodiment of the invention;

FIG. 2 is a partial side view of the first embodiment showing a first housing with a control panel coupled thereto;

FIG. 3 is another partial side view of the first embodiment showing a second housing with a data disk reader coupled thereto;

FIG. 4 is a rear view of a second embodiment of the invention; and

FIG. 5 is a side view of a third embodiment of the invention.

### DETAILED DESCRIPTION OF THE INVENTION

Referring now specifically to the drawings, there is illustrated a headset 10 including a head assembly 11, a data disk reader 12, a control panel 14 for controlling operation of the data disk reader 12, a first housing 16, including a speaker 18, with control panel 14 coupled thereto, and a second housing 20, including a speaker 22, with data disk reader 12 coupled thereto.

As illustrated, headset 10 is portable and adapted to be secured to the head/neck area of a user. However, as will be recognized by those skilled in the art, the teachings of the invention are not to be limited to just portable data disk headset players. Additionally, while two speakers are illustrated, it should be recognized that a similar headset comprising a single speaker can also be used. Finally, it should be known that some or all of the housings described below are not required to implement the invention.

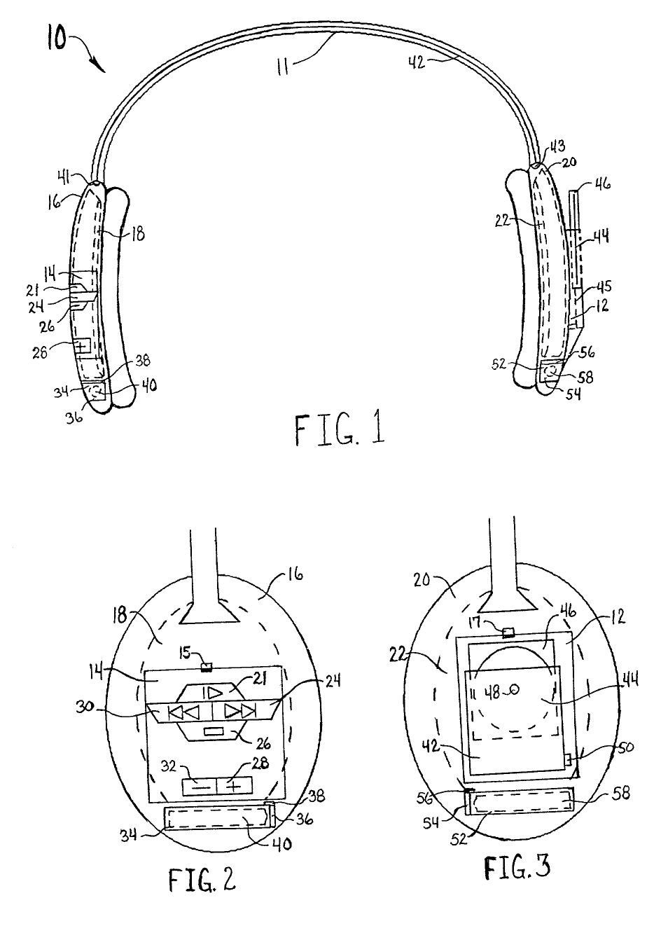

In a first embodiment, shown in FIGS. 1-3, control panel 14 is coupled to first housing 16 using a control panel coupler 15. It should be recognized that control panel 14 may be permanently or detachably coupled to head assembly 10, or housings 16 or 20. Numerous mechanisms for coupling control panel 14 are possible, including a slot, hinge, compartment, hook and latch fasteners, clips, glue, buttons, buckles, snaps, screws, etc. Control input devices 21, 24, 26, 28, 30 and 32 provide an interface for control panel 14 allowing a user to control the operation of data disk reader 12.

A power source housing 34 is shown located in first housing 16. A hinged door 36 may be provided to gain access to power source housing 34. As shown, hinged door 36 is attached to first housing 16 by a hinged fastener 38. It should be recognized, however, that other door mechanisms as known in the art are also possible with the invention, e.g., a retractable door system, detachable door, etc. Additionally, it should be recognized that power source housing 34 may be located in control panel 14. A power source 40 may be a dry cell type of power source but other power sources known in the art are also possible with the invention, e.g., corded adaptor plugins, solar cells, nuclear capsules, etc. Power source 40 is contained in power source housing 34.

Referring to FIG. 1, a first end 41 of head assembly 11 is coupled to first housing 16, and a second end 43 of head assembly 11 is coupled to second housing 20. Conductive material 42 is shown included within head assembly 11. Conductive material 42 is used to transmit data between the data disk reader 12, control panel 14 and speaker(s) 18, 22. Conductive material 42 may be comprised of copper wire, ceramic material, etc. Data disk reader 12 and control panel 14 can be either directly connected to conductive material 42, or conductive material 42 may be connected to similar conductive material within housings 16 and 20 which then connects to control panel 14, data disk reader 12, and speaker(s) 18, 22. While conductive material 42 is shown, it should be recognized, that other materials and transmitting devices as known in the art are also possible with the invention, e.g., infrared red sensors, fiber optics, lasers, etc.

Data disk reader 12 is shown coupled to second housing 20 using a reader coupler 17. It should be recognized that data disk reader 12 may be permanently or detachably coupled to head assembly 10, or housings 16 or 20. Numerous mechanisms for coupling data disk reader 12 are possible including a slot, hinge, compartment, hook and latch fastener, clips, glue, buttons, buckles, snaps, screws, etc. A data disk compartment 45, formed in a side of data disk reader 12, is provided. A data disk 44 (shown partially inserted) may be placed in a data disk holder 46. A positioning post 48 can be used to keep data disk 44 centralized. A locking tab 50 holds data disk holder 46 in place. When it is necessary to remove data disk holder 46 from data disk compartment 45, locking tab 50 may be pressed and data disk holder 46 is released. It should be recognized, however, that other locking mechanisms as known in the art are also possible with the invention, e.g., a hinged or retractable door system may be used to secure and protect data disk 44 with or without data disk holder 46. A power source compartment 52 may be provided in second housing 20. A hinged door 54 may be provided to gain access to power source compartment 52. As shown, hinged door 54 is attached to second housing 20 by a hinged fastener 56. It should be recognized, however, that other door mechanisms as known in the art are also possible with the invention, e.g., a retractable door system, detachable door, etc. Additionally, it should be recognized that power source compartment 52 may be located on data disk reader 12. A power source 58 may be a dry cell type of power source but other power sources known in the art are also possible with the invention, e.g., corded adapter plugins, solar cells, nuclear capsules, etc. Power source 58 is contained in power source compartment 52.

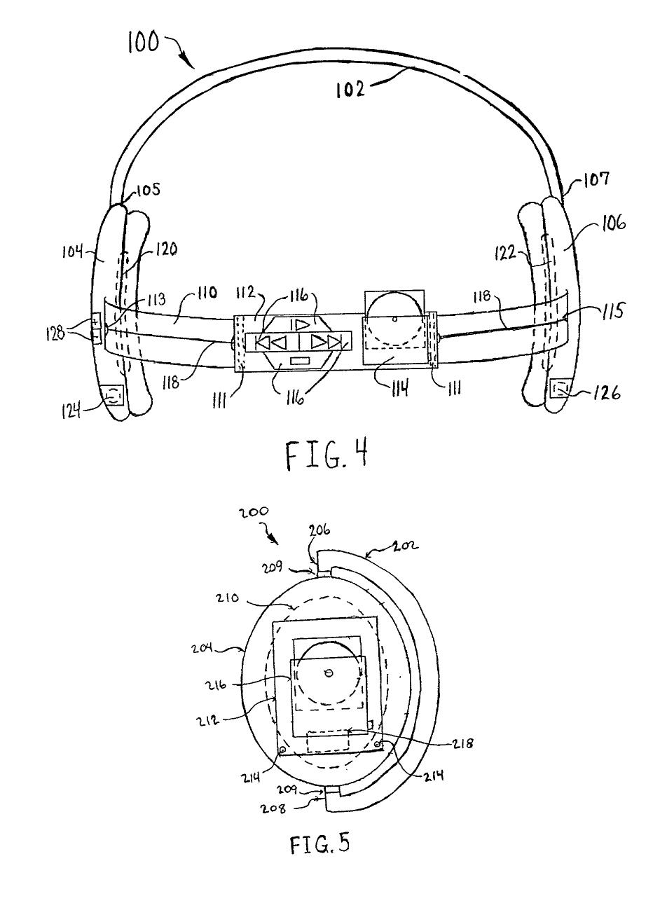

Referring to FIG. 4, a second embodiment of a headset 100 is disclosed. This embodiment includes: a first assembly 102, a first housing 104 coupled to a first end 105 of first assembly 102, a second housing 106 coupled to a second end 107 of first assembly 102 and a second assembly 110 with a first end 113 coupled to first housing 104 and a second end 115 coupled to second housing 106. A speaker 120 is located within first housing 104 and a speaker 122 may be located within second housing 106. A panel 112 is shown coupled to second assembly 110 using a coupler 111. Panel 112 includes a data disk reader 114 and controls 116. However, data disk reader 114 and controls 116 may be placed on separate panels. Panel 112 may be coupled to housings 104, 106, first assembly 102 or second assembly 110. Mechanisms for coupling panel 112 include a slot, hinge, compartment, hook and latch fastener, clips, glue, buttons, buckles, snaps, screws, etc. Second assembly 110 contains conductive material 118 that allows the data disk reader 114 to communicate with speaker(s) 120, 122. Additionally, conductive material 118 may provide power from a power source 124 and an optional power source 126 to controls 116 and/or data disk reader 114. It should be recognized that power source 124 and power source 126 may be placed in the same housing. Alternatively, a single power source may be used and may be placed on panel 112. Volume controls 128 are shown on first housing 104, and communicate with data disk reader 114 through conductive material 118. It should be recognized that volume controls 128 may be placed on housings 104, 106, panel 112 or on a second panel coupled to assembly 102 or 110.

FIG. 5 displays a third embodiment of a headset 200. This embodiment includes: an assembly 202, a housing 204 coupled to a first end 206 and second end 208 of assembly 202. Housing 204 is shown coupled to assembly 202 using hinges 209, allowing for the independent movement of housing 204 and assembly 202. A speaker 210 is located within housing 204. Assembly 202 is formed to secure headset 200 to the ear of a user and placing speaker 210 over the ear. A panel 212 is shown coupled to housing 204 using two screws 214. Panel 212 includes a data disk reader 216 which communicates with speaker 210. Mechanisms for coupling panel 212 include a slot, hinge, compartment, hook and latch fastener, clips, glue, buttons, buckles, snaps, screws, etc. Power source 218 is shown as part of panel 212. Power source 218 provides power to data disk reader 216. Controls for controlling the operation of the data disk reader 216 are remote from the headset 200.

In the above embodiments, housings 16, 20, 104, 106 and 204 are made from the same material, e.g., a form of polyurethane, polyethylene, etc. Of course, other synthetic and natural materials having similar structural characteristics may also be utilized if desired.

With regard to the data disk holder described above, it should be recognized that a door may be used to protect the data disk, e.g., hinged door assembly, retractable door system, etc. Additionally, it should be recognized that the data disk is smaller than a CD, and data disks of sizes other than that shown are possible. With regard to the data disk, any portable, removable data storage means now known or later developed can be used in conjunction with the present invention.

The foregoing description of the preferred embodiments of the invention has been presented for purposes of illustration and description. It is not to be intended to be exhaustive or to limit the invention to the precise form disclosed, and obviously many modifications and variations are possible in light of the above teaching. Such modifications and variations that may be apparent to a skilled person in the art are intended to be included within the scope of this invention as defined by the accompanying claims.

What is claimed is:

1. A headset comprising:
a head assembly for securing to the head of a user;
at least one housing, including a speaker, coupled to the head assembly; and
a data disk reader coupled to one of the head assembly and the at least one housing;
wherein the data disk reader communicates with each speaker.

2. The headset of claim 1, further comprising a reader coupler adapted to couple the data disk reader to one of the head assembly and the at least one housing.

3. The headset of claim 1, further comprising:
a first housing coupled to a first end of the head assembly; and
a second housing coupled to a second end of the head assembly.

4. The headset of claim 3, further comprising a reader coupler on one of the first and second housings; the reader coupler adapted to couple the data disk reader to a housing.

5. The headset of claim 1, further comprising a control panel for controlling operation of the data disk reader.

6. The headset of claim 5, further comprising:
a control panel coupler adapted to couple the control panel to one of the head assembly and the at least one housing; and
a reader coupler adapted to couple the data disk reader to one of the head assembly and the at least one housing.

7. The headset of claim 6, wherein the control panel coupler and the data disk reader coupler are substantially identical.

8. The headset of claim 5, further comprising:
a first housing coupled to a first end of the head assembly; and
a second housing coupled to a second end of the head assembly.

9. The headset of claim 8, further comprising a data disk reader coupler on one of the first and second housings; the data disk reader coupler adapted to couple the data disk reader to a housing.

10. The headset of claim 9, further comprising a control panel coupler on one of the first and second housings; the control panel coupler adapted to couple the control panel to a housing.

11. The headset of claim 10, wherein the data disk reader coupler and control panel coupler are substantially identical.

12. A headset having a head assembly for securing to the head of a user, the headset comprising:
at least one housing, including a speaker, coupled to the head assembly;
a data disk reader, coupled to one of the head assembly and the at least one housing, that communicates with each speaker; and
at least one power source;
wherein the at least one power source provides power to operate the data disk reader.

13. The headset of claim 12, further comprising a control panel for controlling operation of the data disk reader.

14. The headset of claim 13, wherein the at least one power source provides power to the control panel.

15. A headset comprising:
a first assembly for securing to the head of a user;
at least one housing, including a speaker, coupled to the first assembly;
a second assembly coupled to one of the first assembly and the at least one housing; and
a data disk reader that communicates with each speaker, coupled to one of the first assembly, the second assembly and the at least one housing.

16. The headset of claim 15, wherein the second assembly includes a reader coupler adapted to couple the data disk reader to the second assembly.

17. The headset of claim 15, wherein the second assembly includes material allowing the data disk reader to communicate with each speaker.

18. The headset of claim 15, further comprising a control panel for controlling operation of the data disk reader.

19. The headset of claim 18, wherein the second assembly includes a coupler adapted to couple the control panel to the second assembly.

20. The headset of claim 18, wherein the second assembly includes material allowing the control panel to communicate with the data disk reader.

21. A portable data disk reader for use with a headset having a head assembly for securing to the head of a user and at least one speaker, the data disk reader comprising:
means for reading a data disk;
means for attaching the means for reading a data disk to the head assembly;
means for communicating the means for reading a data disk to each of the at least one speaker; and
means for supplying power to the means for reading a data disk.

22. The portable data disk reader of claim 21, further comprising:
means for controlling the means for reading a data disk;
means for attaching the means for controlling to the head assembly; and
means for supplying power to the means for controlling.

23. A headset having a head assembly for securing the headset to the head of a user and at least one speaker, the headset comprising:
means for reading a data disk coupled to the head assembly;
means for communicating the means for reading a data disk with each of the at least one speaker; and
means for supplying power to the means for reading a data disk.

24. The headset of claim 23, further comprising:
means for controlling the means for reading a data disk; and
means for supplying power to the means for controlling.
